(19) United States
(12) Patent Application Publication
(10) Pub. No.: US 2002/0178965 A1
(43) Pub. Date: Dec. 5, 2002

(54) Helix windings for linear propulsion systems

(76) Inventor: Kent Davey, New Smyrna Beach, FL (US)

Correspondence Address: Levisoln, Lerner, Berger & Langsam, Suite 2400, 757 Third Avenue, New York, NY, 10017, US

(21) Appl. No.: 09/874,569

(22) Filed: Jun. 5, 2001

(51) Int. Cl. B60L 13/04

(52) U.S. Cl. 104/281

(57) ABSTRACT

Maglev propulsion systems commonly employ either synchronous fields with a serpentine winding or a linear induction motor winding. Another alternative is a simpler heliical winding, the current for which is injected via a sliding contact. Long stator machines are forced to excite a lot more track than is required at any time and to place expensive switch gear along the track. Short stator induction machines are forced to perform much of the power handling on the vehicle and to deal with entry drag effects. A brush on the vehicle excites a helix winding on the track and eliminates both problems and uses the same magnetic field employed to get lift and guidance to supply propulsion. Because only a small section of the track is excited at a time, the efficiency is very high.

### RELATED APPLICATIONS

None

Field of the Invention

The invention relates to magnetic levitation (“maglev”) systems in general, and particularly to a magnetic levitation lineal propulsion system having a helix winding that generates propulsion using the same magnetic field responsible for generating lift and guidance forces in this maglev system.

### BACKGROUND OF THE INVENTION

The present invention relates to linear propulsion. The favored technique for generating linear forces for maglev applications is with a long stator linear synchronous motor (LSM), or a short stator linear induction motor (LIM). The long stator synchronous motor suffers the drawback of requiring switchgear to activate selected portions of the track at any one time. It would be too inefficient to activate the entire track at once. Even with this provision the losses commensurate with exciting the coils outside the vehicle length are significant.

The short stator linear induction motor (LIM) suffers from two requirements. First, the entry effect for the linear induction field causes a significant drag force, diminishing the LIM's effective thrust. Second, the power management, specifically the variable frequency field, must be accomplished on the vehicle. At higher speeds and thus power, the power electronics become heavy; further the higher frequency is commensurate with a lower power factor for the induction motor.

Yet another alternative for getting linear thrust is to use a short stator linear reluctance motor (LRM). One advantage of this approach is that the secondary member is inexpensive, consisting only of steel. However, the system utilizing LRM suffers all the disadvantages of the LIM approach, and has the additional disadvantage of its motor being inherently less efficient than an LSM.

U.S. Pat. No. 5,053,654 awarded to Augsburger, et al. on Oct. 1, 1991 (fully incorporated herein by reference) discusses the LSM approach and the problems associated with the required switchgear. Augsburger attempts to improve the efficiency of the system by a plurality of tap points and several substations which provide power in varying proportions depending on the position of the vehicle.

U.S. Pat. No. 3,967,561 awarded to Schwarzler on Jul. 6, 1976 (fully incorporated herein by reference) shows the use of a LIM to generate propulsion against an aluminum plate sitting on top of a stack of guideway laminations. These devices are typically levitated through an active electromagnet as suggested by U.S. Pat. No. 3,804,022 (awarded to Schwarzler et al. in April, 1974 and fully incorporated herein by reference). U.S. Pat. No. 5,152,227 (awarded to Kato on Oct. 6, 1992 and fully incorporated herein by reference) describes a means for aligning multiple cores used to lift a maglev vehicle. Therefore, there is a need in the art for a maglev system having a simple winding accomplishing lift, propulsion and guidance simultaneously. There is also a need in the art for a maglev system where only a portion of the track is excited at a particular point in time.

### SUMMARY OF THE INVENTION

The object of the present invention is to realize propulsion using a simple winding, preferably comprising a single turn winding in the shape of a helix. Magnetic flux is driven into a ferromagnetic structure and driven longitudinally in the travel direction. The transverse flux interacts with the current in the helix to produce force. The device is in fact a simplified linear dc motor comprising the equivalent of a continuous Gramme ring type winding. The magnetic field is preferably driven into the plate from both the lower and upper sides using an electromagnet affixed to the vehicle. This same field can be used to augment guidance and in some cases levitation forces. In the event of a power loss, a voltage will be induced into the helix winding. Since the brushes are in slidable contact with the helix winding, dc power becomes available to the vehicle to maintain lift and guidance, translating kinetic energy into lift and guidance energy.

The simple helical winding combined with a double electromagnet placement increases the efficiency of the linear motor. Since only a portion of the track is excited using brushes, no guideway switches are required, and the losses from exciting a long portion of the guideway track are eliminated. The winding employs a dc injected current, and thus circumvents the disadvantage of requiring a lot of power handling on the vehicle. In addition, the use of the electromagnets above and below the guideway at high field levels greatly increases the guidance forces resulting from the simple laminations affixed to the guideway.

### BRIEF DESCRIPTION OF THE DRAWINGS

A full understanding of the invention can be gained from the following description of the preferred embodiment when read in conjunction with the accompanying drawing in which:

FIG. 1 is a cross-sectional, design end schematic view of the maglev system in accordance with one preferred embodiment of the present invention, showing the guideway laminations and the vehicle magnets;

FIG. 2 is a perspective schematic view of the helix-wound guideway showing a steel plate placed under the helical winding;

FIG. 3 is a cross-sectional, design end schematic view of the maglev system in accordance with another preferred embodiment of the present invention, showing the use of two electromagnets, i.e., one electromagnet above and one below the guideway laminations, which improve thrust efficiency;

FIG. 4 is a cross-sectional schematic side view of the lift and thrust electromagnets layout; and

FIG. 5 is a schematic view of the maglev system in accordance with the present invention having an electromagnet with interpole and compensation winding to suppress commutation arcing and lower the inter winding helix voltage.

### DETAILED DESCRIPTION OF THE PREFERRED EMBODIMENT AND DRAWINGS

Motors with a source of magnetomotive force (MMF) on both sides of the air gap get better the bigger they are. They are typically preferred over motors that have a source of MMF on one side of the air gap only, for example the LRM. This invention uses this principle while attempting to circumvent the shortcomings of the conventional LSM and LIM. In the preferred embodiment of the present invention, a simple winding is used on the stator into which current is to be injected. This current interacts with a magnetic field on the vehicle to generate thrust. The current is injected through brushes, which slide over the helix winding in front of and behind the electromagnets. The electromagnets also serve the purpose of providing lift and guidance. The lift is active. To achieve this active lift, the air gap between the vehicle, specifically the electromagnets, and the track is monitored by a sensor. When the sensor detects a change in the size of the monitored air gap, the current in the electromagnets is adjusted to maintain a lifted position of the vehicle. The guidance in the system, however, is passive. Any lateral displacement of the vehicle from the alignment results in magnetic force directed at the maglev vehicle and acting to realign the guideway steel with the electromagnets. The guideway preferably consists of steel laminations around which the helix winding is wound.

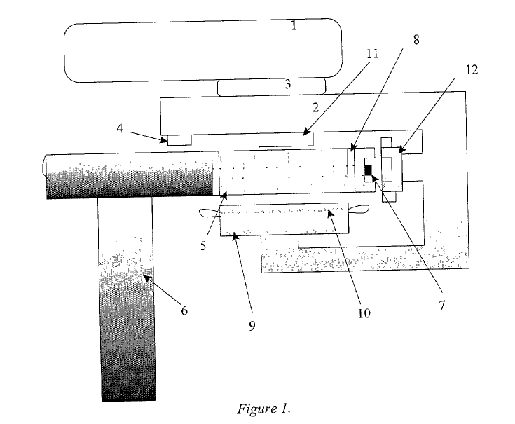

Shown in FIG. 1 is one preferred embodiment of the maglev system design. The active electromagnet exerts an upward force on the vehicle. The electromagnetic field from the electromagnet 9 is driven into the guideway steel, along the track travel direction, and then back into a paired electromagnet. The vehicle body 1 is attached to the bogie 2 through an air spring 3. A landing skid 4 is set to catch the vehicle if the electromagnet support should fail. The guideway laminations 5 orient along the travel direction and are affixed to the structural concrete support 6 through bolts 7. An aluminum end plate 8 fits over the wire helix (not shown). The electromagnet 9 is attached to the bogie and supplies the magnetic field to generate lift, guidance, and thrust, itself being excited by a control winding 10. Current is injected into the helix via a sliding contact of brush 11 in the same manner that a dc motor is excited. To augment guidance, a separate lateral electromagnet 12 may be employed.

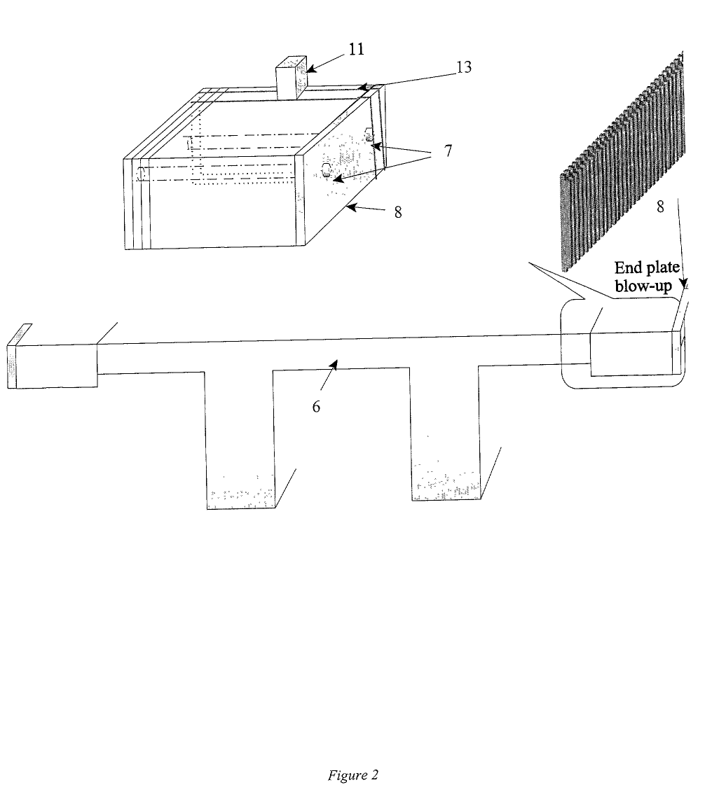

Shown in FIG. 2 is the helix winding 13 wound around the guideway lamination structure. Current is driven into the winding through a brush 11 affixed to the vehicle. As the vehicle drives past the guideway, the brush 11 maintains a slidable contact with the helix winding, thereby exciting it. An end plate 8 preferably of aluminum is notched so that the wire of the helix winding fits into the notches, as shown in the end-plate blow up of FIG. 2. Bolts 7 affix the guideway 5 with laminations oriented in the travel direction to the structural concrete support 6.

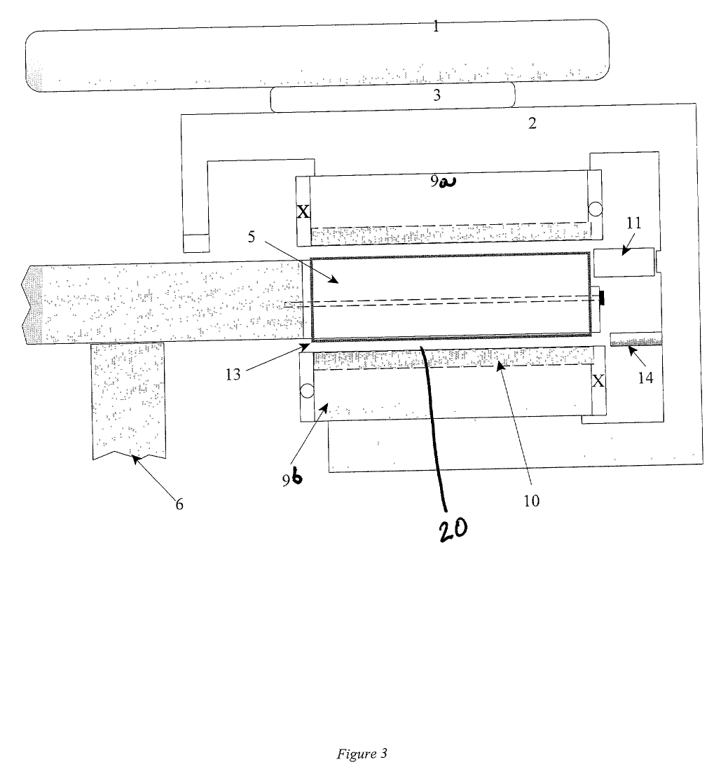

In this configuration the magnetic field for lift and thrust is the same. The lift field in the system is precisely controlled, and is proportional to the B field squared. The thrust is proportional to the B field. In practice, performing both tasks results in an electromagnet with a weaker B field, covering more distance to allow the thrust to build. Consequently it is preferable to utilize a maglev system having two paired electromagnets flanking the guideway, where vertically corresponding poles of these paired electromagnets have opposite polarity. This preferred geometry is shown in FIG. 3. In this embodiment, when the paired electromagnets 9a and 9b are activated by the control winding 10, they drive flux into the same point of the helix winding and then down the travel direction. Such a geometry allows the B field to be driven up considerably. The brush 11 is preferably attached to the side of the bogie 2 for inserting current into the helix winding 13 of the guideway 5. An inductive sensor 14 is used to monitor the air gap 20. When the air gap 20 is increased or reduced to fall outside its allowed size, the inductive sensor 14 adjusts the current in the control winding 10, thereby changing the intensity of the magnetic field and the lift force generated by the paired electromagnets 9a and 9b. This adjustment continues until the original air gap is restored.

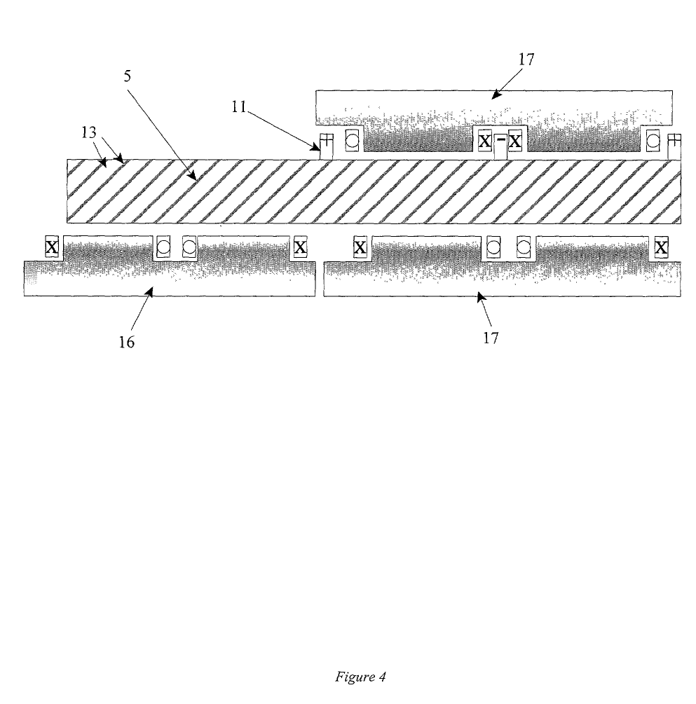

Although not necessary, it is convenient in practice to separate the electromagnet functions. Shown in FIG. 4 is a side view of the layout of electromagnets on the bogie. In this embodiment, the two leading electromagnets 16 preferably only perform the function of lift. They are followed by paired electromagnets 17 which drive magnetic flux into the track from above and below, and use a higher magnetic field. The current in the leading electromagnets 16 is controlled by the air gap sensor (not shown), and directed to maintain a fixed air gap usually in the neighborhood of 10 mm. The trailing electromagnets 17 are driven at a higher magnetic flux level. When the guideway is centered between electromagnets, i.e. when the air gap is stabilized at its desired size, the trailing pair of electromagnets will not generate any lift regardless of the field strength. This high B field is then used to generate thrust with a nominal current. Since thrust is equal to BLi, where L is the working conductor length, B is the magnetic field density, and i is the current flowing in the helix winding, a high thrust can be achieved with a modest current. The brushes 11 are excited to realize the polarity indicated by the (±) signs. In this preferred embodiment, the current injected into these paired electromagnets 17 is also controlled. The control logic can be configured to maintain a zero vertical force, or to augment the lift force from magnets 16 slightly. Either is possible. In both cases the magnetic field density should be near the material saturation strength. Having only electromagnets on the lower surface is generally insufficient to produce adequate guidance. The stronger magnets placed above and below greatly enhance guidance forces even when the lift forces cancel completely.

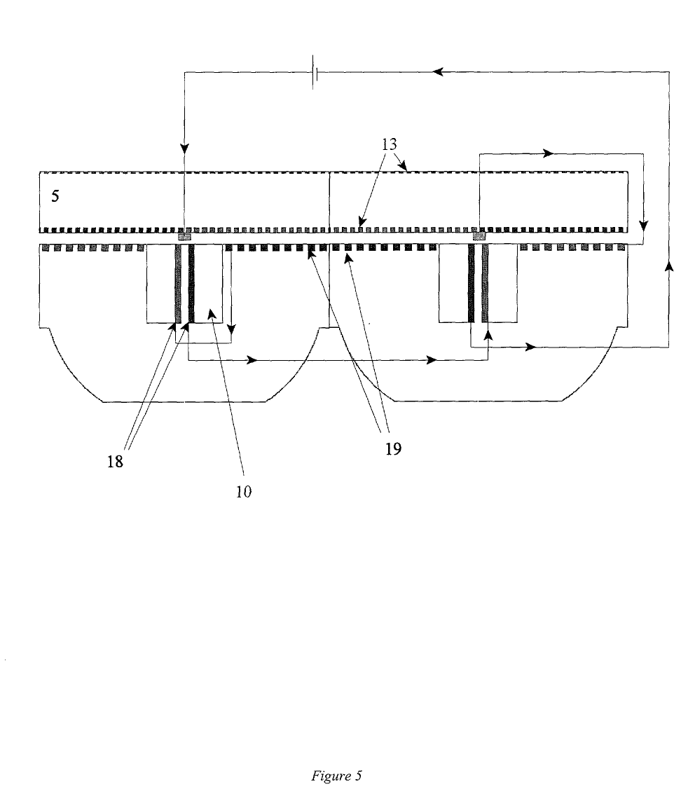

In order to suppress arcing, conventional dc motors employ interpoles. These small magnetic poles may be utilized with the present invention by inserting them between the primary magnet poles to suppress any voltage induced in the helix winding during commutation. In addition, to maintain an even voltage distribution over the helix, and allow operations at higher voltages, a compensation winding may also be employed with the present invention to counteract armature reaction. Both are shown in FIG. 5, as they might be excited in a more appropriate electromagnet lamination. The interpole winding 18 drives flux into the helix winding 13 of the guideway 5 so as to lower the induced self voltage. The compensation winding 19 lies on the surface of the electromagnet and offsets the self field from the helix current.

Having described this invention with regard to specific embodiments, it is to be understood that the description is not meant as a limitation since further variations or modifications may be apparent or may suggest themselves to those skilled in the art. It is intended that the present application cover such variations and modifications as fall within the scope of the appended claims.

I claim as follows:

1. A magnetic propulsion, levitation and guidance system comprising:
a vehicle;
a track, said track comprising a helix winding;
at least one brush mounted on said vehicle and connected to a source of electrical current, said brush being in slidable contact with said helix winding and being configured to inject said electrical current into said helix winding; and
at least one source of magnetic field, said source being mounted on said vehicle, wherein when said electrical current is injected into said helix winding, said helix winding and said source of magnetic field interact to generate lift, propulsion and guidance for said vehicle.

2. A magnetic propulsion, levitation and guidance system according to claim 1 wherein said at least one source of magnetic field comprises an electromagnet.

3. A magnetic propulsion, levitation and guidance system according to claim 2 further comprising a gap sensor, said gap sensor being configured to adjust an electrical current in said electromagnet to maintain a desired gap between said vehicle and said track.

4. A magnetic propulsion, levitation and guidance system according to claim 1 further comprising a landing skid mounted on said vehicle, said landing skid being configured to support said vehicle if said generated lift fails.

5. A magnetic propulsion, levitation and guidance system according to claim 1 further comprising a lateral electromagnet mounted on said vehicle, said lateral electromagnet being configured to interact with said helix winding of said guideway to augment guidance for said vehicle.

6. A magnetic propulsion, levitation and guidance system comprising:
a vehicle;
a track, said track comprising a guideway, said guideway further comprising a helix winding;
at least one brush mounted on said vehicle and connected to a source of electrical current, said brush being in slidable contact with said helix winding and being configured to inject said electrical current into said helix winding; and
at least two electromagnets, said two electromagnets being mounted on said vehicle, wherein said two electromagnets are located on opposite sides of said guideway, and wherein, when said electrical current is injected into said helix winding, said helix winding and said two electromagnets interact to generate lift, propulsion and guidance for said vehicle.

7. A magnetic propulsion, levitation and guidance system according to claim 6, wherein each of said two electromagnets further comprise at least two magnetic poles, and wherein corresponding magnetic poles of said two electromagnets have opposite polarity.

8. A magnetic propulsion, levitation and guidance system according to claim 7, further comprising at least two interpoles, each of said two interpoles being inserted between said two poles of each of said two electromagnets, said interpoles being configured to suppress arcing during commutation.

9. A magnetic propulsion, levitation and guidance system according to claim 6, wherein said two electromagnets generate magnetic flux directed toward the same point within said helix winding.

10. A magnetic propulsion, levitation and guidance system according to claim 6 further comprising a landing skid mounted on said vehicle, said landing skid being configured to support said vehicle if said generated lift fails.

11. A magnetic propulsion, levitation and guidance system according to claim 6 further comprising a gap sensor, said gap sensor being configured to adjust a control electrical current in said two electromagnets to maintain a desired gap between said vehicle and said track.

12. A magnetic propulsion, levitation and guidance system according to claim 6 wherein each of said two electromagnets further comprise a control winding, said control winding being configured to modify the electromagnetic field of each of said electromagnets when a control current is injected into said control winding.

13. A magnetic propulsion, levitation and guidance system according to claim 6 wherein each of said two electromagnets further comprise a compensation winding, said compensation winding laying on a surface of each of said two electromagnets, said compensation winding being configured to offset a self field from a current within said helix winding.

14. A magnetic propulsion, levitation and guidance system comprising:
a track, said track comprising a guideway, said guideway further comprising a helix winding;
a vehicle, said vehicle having a means for exciting said helix winding; and
at least two electromagnets mounted on said vehicle, each of said two electromagnets further comprising at least two magnetic poles, wherein said two electromagnets are located on opposite sides of said guideway, wherein corresponding magnetic poles of said two electromagnets have opposite polarity, and wherein, when said helix winding is excited, said helix winding and said two electromagnets interact to generate lift, propulsion and guidance for said vehicle.

15. A magnetic propulsion, levitation and guidance system according to claim 14, wherein said two electromagnets generate magnetic flux directed toward the same point within said helix winding.

16. A magnetic propulsion, levitation and guidance system according to claim 14, wherein said means for exciting said helix winding comprises at least one brush mounted on said vehicle and connected to a source of electrical current, said brush being in slidable contact with said helix winding and being configured to inject said electrical current into said helix winding.

17. A magnetic propulsion, levitation and guidance system according to claim 14 further comprising a landing skid mounted on said vehicle, said landing skid being configured to support said vehicle if said generated lift fails.

18. A magnetic propulsion, levitation and guidance system according to claim 14 further comprising a gap sensor, said gap sensor being configured to adjust the magnetic field of said two electromagnets to maintain a desired gap between said vehicle and said track.

19. A magnetic propulsion, levitation and guidance system according to claim 14, further comprising at least two interpoles, each of said two interpoles being inserted between said two poles of each of said two electromagnets, said interpoles being configured to suppress arcing during commutation.

20. A magnetic propulsion, levitation and guidance system according to claim 14 wherein each of said two electromagnets further comprise a compensation winding, said compensation winding laying on a surface of each of said two electromagnets, said compensation winding being configured to offset a self field from a current within said helix winding.

21. A magnetic propulsion, levitation and guidance system comprising:
a track, said track comprising a guideway, said guideway further comprising a helix winding;
a vehicle, said vehicle having a means for exciting said helix winding;
a first set of at least two electromagnets mounted on said vehicle, said two electromagnets of said first set being located on opposite sides of said guideway; and
a second set of at least two electromagnets mounted on said vehicle, each of said two electromagnets of said second set further comprising at least two magnetic poles, wherein said two electromagnets of said second set are located on opposite sides of said guideway, wherein corresponding magnetic poles of said two electromagnets of said second set have opposite polarity, and wherein, when said helix winding is excited, said helix winding and said two electromagnets of said first set interact to generate lift, and said helix winding and said two electromagnets of said second set interact to generate propulsion and guidance for said vehicle.

22. A magnetic propulsion, levitation and guidance system according to claim 21 further comprising a gap sensor, said gap sensor being configured to adjust magnetic field of said two electromagnets of said first set of electromagnets to maintain a desired gap between said vehicle and said track.

23. A magnetic propulsion, levitation and guidance system according to claim 21, wherein said two electromagnets of said second set of electromagnets generate magnetic flux directed toward the same point within said helix winding.

24. A magnetic propulsion, levitation and guidance system according to claim 21, wherein
